(19) United States
(12) Patent Application Publication
(10) Pub. No.: US 2009/0166908 A1
(43) Pub. Date: Jul. 2, 2009

(54) Innovation control process for specific porosity/gas permeability of electrode layers of SOFC-MEA through combination of sintering and pore former scheme and technology

(76) Inventors: MAW-CHWAIN LEE, Taoyuan County (TW); YANG-CHUANG CHANG, Taoyuan County (TW); TAI-NAN LIN, Taoyuan County (TW); WEI-XIN KAO, Taoyuan County (TW); CHUN-HSIU WANG, Taoyuan County (TW); LI-FU LIN, Taoyuan County (TW)

Correspondence Address: MICHAEL LIN, 5F 79 Roosevelt Rd. Sec. 2, TAIPEI, 106, TW

(21) Appl. No.: 11/968,197

(22) Filed: Jan. 2, 2008

(51) Int. Cl. B29C 65/02

(52) U.S. Cl. 264/40.1

(57) ABSTRACT

An innovation scheme and technology used for controlling porosity/gas permeability of electrode layers of SOFC-MEA through combination of pore former and sintering manipulations. The porosity of electrode layer is 0-35 vol. %, and the gas permeability of electrode layer is 1×10⁻³−1×10⁻⁶ L/cm²/sec.

### BACKGROUND OF THE INVENTION

1. Field of the Invention

The invention relates to a manufacturing technology for the electrode layer of solid oxide fuel cell-membrane electrode assembly (SOFC-MEA). Especially, it refers to an innovative process that combines pore former and sintering technology to produce the electrode layer for SOFC-MEA with specific porosity and gas permeability. This manufacturing process to produce SOFC-MEA possesses high reliability and flexibility.

2. Description of the Prior Art

With increasing oil price and rising consciousness of environmental protection, renewable energy and high energy conversion technology is one of the most technological development in this century. Solid oxide fuel cell is a power generation system that has high efficiency, low pollution and high versatility of fuel sources. Besides, its features such as simple material composition, modulized structure and sustainable power generation ability make it the power generation system with the greatest potential.

Among all, planar solid oxide fuel cell can overcome long circuit loss and have uniform current collection, so it has increased cell power density. This is also why planar solid oxide fuel cell is the primary interest for most development teams in the world.

The development for the first-generation solid oxide fuel cell used electrolyte as cell supporting substrate (Electrolyte Supported Cell, ESC in short). But because the electrolyte layer was too thick (about 120˜150 micrometers), the resistance was increased and the power density was decreased. Thus, it relied on high temperature operation (about 850˜1000° C.) to obtain desired cell performance, which limited the use of solid oxide fuel cell. The second-generation solid oxide fuel cell used electrode as supporting substrate and anode supported cell (ASC) was the primary cell structure in development. Such cell used over 600 micrometer thick anode as supporting substrate to provide cell with high mechanical strength, and coated electrolyte (5˜20 micrometers) and cathode (30˜50 micrometers) in sequence onto the anode substrate. Because the electrolyte thickness was decreased, its operation temperature could be lowered to about 700˜850° C., which not only solved the material sealing issue with the planar solid oxide fuel cell but also lowered its manufacturing cost. This type of cell also greatly stimulated the development and applications of solid oxide fuel cell. Presently, many countries in the world have started huge investment in the development of solid oxide fuel cell. Besides, there are companies that can produce anode supported cells in a large scale that is leading the solid oxide fuel cell to commercialization.

The electrode layer of solid oxide fuel cell is porous to enhance the transport of fuel gases and oxidant gases. Usually, it simply adjusts the amount of pore former to control the porosity of the electrode supporting substrate. Present research reports indicated the pore volume percentage should be between 10% and 25%. However, high porosity will cause the decrease in mechanical strength of electrode supporting cell and tend to damage unit cell. But low porosity will cause concentration polarization and decrease cell performance.

Therefore, the invention used a novel process that combined pore former and sintering technology to produce the electrode layer for solid oxide fuel cell-membrane electrode assembly with specific porosity and gas permeability as well as high mechanical strength and high process reliability.

### SUMMARY OF THE INVENTION

The main objective for the invention is to develop the manufacturing process for the electrode layer of solid oxide fuel cell-membrane electrode assembly with specific porosity and gas permeability.

To achieve the above objective, the invention used a novel process that combined pore former and sintering technology. Taking anode supported cell (ASC) as example, the process in the invention added pore former into anode slurry and used ball mill to obtain uniform mixing. The composition of the anode slurry was NiO, 8YSZ, solvent, dispersant, plasticizer and binder. The electrode green tape was made by tape casting technology, followed by lamination technology to adjust substrate thickness and geometric structure. Anode green substrate was subject to high-temperature sintering, which used the control setting for temperature profile of sintering cycle (sintering curve) for sintering atmosphere and gas flow rate. Finally, the process could produce anode supported cell with specific porosity and gas permeability.

In a preferred embodiment, the ingredient for the above pore former was graphite in a weight percent of 0.1˜10%, or pore former index of 0.1˜10. The pore former index is defined as the weight of added pore former in grams per 100 grams of anode powder.

In a preferred embodiment, the above mentioned sintering temperature could be 1250˜1400° C., and temperature increasing rate was 0.2˜1° C., and temperature decreasing rate was 0.5˜1° C., and sintering atmosphere was air with flow rate of 0˜60 c.c./min.

### DETAILED DESCRIPTION OF THE PREFERRED EMBODIMENT

The manufacturing technology for solid oxide fuel cell in the invention is a novel process that combines pore former and sintering technology to produce the electrode layer of solid oxide fuel cell-membrane electrode assembly with specific porosity and gas permeability. This manufacturing process to produce SOFC-MEA possesses high reliability and flexibility, and at least consists of the following steps:

Step 1: Produce anode supported cell. First, prepare 50% NiO and 50% 8YSZ (8 mol. % Yttria-Stablized Zirconia) by weight, and a specific amount of pore former (graphite) as basic composition. Add a proper amount of solvent (Ethanol/Ethyl Methyl Ketone, MEK), dispersant (Tri-Ethanolamine, TEA), plasticizer (Polyethylene Glycol, PEG/Dibutyl phthalate, DBP) and binder (Polyvinyl Butyral, PVB). Use ball mill for uniform mixing. Use tape casting to make electrode green tape. Use lamination to make 1000 μm thick anode green substrate with dimensions of 5×5 cm² and 10×10 cm².

Step 2: Conduct high-temperature sintering of green substrate to obtain anode ceramic substrate (or anode supported substrate). The sintering for green substrate has two cycles: in the first cycle temperature rises to 1250° C.; in the second cycle, the temperature rises to 1400° C. The sintering curve in the process has two kinds: for the first kind, both temperature increasing rate and decreasing rate are fixed at 1° C./min (sintering curve A, as shown in FIG. 1); for the second kind, the temperature increasing rate is 0.2˜1° C. and temperature decreasing rate is 0.5˜1° C. (sintering curve B, as shown in FIG. 2). The sintering atmosphere was air with flow rate of 0˜60 c.c./min.

Step 3: Use pycnometer and analytical equipment for gas permeability to measure porosity and gas permeability of anode supported cell. Also measure the mechanical strength of anode supported substrate as references for quality control.

Through the above steps, anode ceramic substrate could be made for solid oxide fuel cell with specific porosity and gas permeability. The following describes the embodiments for the invention in details:

### Embodiment 1

Step 1: Prepare 50% NiO and 50% 8YSZ by weight, and a specific amount of pore former (graphite) as basic composition. Anode powder (NiO+8YSZ) takes up 35˜80% by weight. The pore former takes up 0˜4% of anode powder by weight, or the pore former index is 0˜4. Add a proper amount of solvent (Ethanol/Ethyl Methyl Ketone), dispersant (Tri-Ethanolamine), plasticizer (Polyethylene Glycol, PEG/Dibutyl phthalate) and binder (Polyvinyl Butyral) in weight percent of 15˜25%, 1˜2%, 2˜3% and 3˜6%, respectively. Then, use ball mill for uniform mixing for 24˜48 hours. Use tape casting to make anode green substrate. Then, use lamination technology to make 800˜1200 μm thick green substrate with dimensions of 5×5 cm² and 10×10 cm².

Step 2: Conduct high-temperature sintering for green substrate at 1250° C. The temperature increasing rate and decreasing rate are fixed at 1° C./min. Conduct the second high-temperature sintering at 1400° C. to increase the strength for the anode substrate. The temperature increasing rate and decreasing rate are also fixed at 1° C./min (sintering curve A). The sintering condition does not include any passing gases. Through the above process, anode supported cell is obtained.

Step 3: Use pycnometer to analyze the obtained anode supported cell. Refer to FIG. 3, which indicates the relationship between pore former amount and anode supported cell porosity with vertical axis for porosity (%) and horizontal axis for pore former index. It is known from FIG. 3 that with increasing pore former, i.e. increasing pore former weight percent, the porosity of anode supported cell also increases, but gradually levels off. This indicates addition of pore former can provide the required porosity of anode substrate. Usually the optimal porosity range is 15˜35%. However, excessively high pore former index has limited effect on the increase in porosity, and also lowers the mechanical strength and production yield of the anode supported cell. It takes special attention for the amount of pore former.

Use the gas permeability equipment to analyze the obtained anode supported cell. Refer to FIG. 4, which indicates the relationship between porosity and gas permeability for the anode supported cell under different pore former indexes with horizontal axis for porosity (%) and vertical axis for gas permeability (L/cm²/sec). It is known from FIG. 4 that the gas permeability greatly increases with the increasing of porosity, which facilitates the transport and reaction for gases in the anode substrate.

### Embodiment 2

Step 1: Prepare 50% NiO and 50% 8YSZ by weight, and a specific amount of pore former (graphite) as basic composition. Anode powder (NiO+8YSZ) takes up 35˜80% by weight. The pore former takes up 0˜4% of anode powder by weight, or the pore former index is 0˜4. Add a proper amount of solvent (Ethanol/Ethyl Methyl Ketone), dispersant (Tri-Ethanolamine), plasticizer (Polyethylene Glycol, PEG/Dibutyl phthalate) and binder (Polyvinyl Butyral) in weight percent of 15˜25%, 1˜2%, 2˜3% and 3˜7%, respectively. Then, use ball mill for uniform mixing for 24˜48 hours. Use tape casting to make anode green substrate. Then, use lamination technology to make 800˜1200 μm thick green substrate with dimensions of 5×5 cm² and 10×10 cm².

Step 2: Conduct high-temperature sintering for green substrate at 1250° C. The temperature increasing rate is 0.2˜1° C./min, while the temperature decreasing rate is 1° C./min. Conduct the second high-temperature sintering at 1400° C. to increase the strength of the anode substrate. The temperature increasing rate is 0.5˜1° C./min, while the temperature decreasing rate is 1° C./min (sintering curve B). Sintering could use air if necessary with gas flow rate of 1˜60 c.c./min. Through the above process, anode supported cell is obtained.

Step 3: Use pycnometer and gas permeability equipment to analyze the obtained anode supported cell. Refer to FIG. 5, from which it is known that when a proper amount of air is passed during sintering, anode supported cell porosity is larger than 15% (volume percent), and gas permeability is larger than 1×10⁻⁴ L/cm²/sec. But the addition of pore former does not have significant effect for improvement.

FIG. 6 shows the relationship between the porosity and gas permeability for anode supported cell under different sintering curves and sintering atmosphere (red hollow circle for sintering curve A, blue hollow triangle for sintering curve B). It is known from FIG. 6 that under low temperature increasing rate (sintering curve B) both the porosity and gas permeability of anode supported cell clearly decrease. But it is through the adjustment of the flow rate of passing air to control the porosity and gas permeability of anode supported cell. FIG. 7 shows the relationship between the porosity and gas permeability of anode supported cell under different pore former index (sintering curve A) or air flow rate (sintering curve B). It is known from FIG. 7 that to obtain desired gas permeability (larger than 1×10⁻⁴ L/cm²/sec) for anode supported cell the pore former index should be higher than 2. But if passing air is used, it is simpler to prepare the anode supported cell with high gas permeability. Please refer to Table 1 for operation conditions and analytical results for all samples.

The result indicates sintering curve B provides better production yield. But the benefit of using pore former to control porosity and gas permeability for the anode supported cell is limited. If additional sintering atmosphere and passing gas are used, it can obtain the anode supported cell with optimal porosity and gas permeability (porosity 15˜35%, gas permeability larger than 1×10⁻⁴ L/cm²/sec). The electrode supported cell for solid oxide fuel cell produced by the process in the invention has specific porosity and gas permeability as well as high mechanical strength and high yield. The product will also meet the requirements by SOFC-MEA manufacturers. It shall meet the requirements for application of patent, which filing is thus submitted.

The content for the above embodiment does not limit the scope of the invention. Those alterations and modifications based on the principles of the invention shall be also covered by the invention

The scope for the protection by the invention shall be according to the claims by the invention.

TABLE 1

| | Pore | | Gas volume | | Gas |
|---|---|---|---|---|---|
| | former | Sintering | flow rate | Porosity | permeability |
| Sample No. | index | curve | (c.c./min) | (vol. %) | (L/cm²/sec) |
| S-17 | 0 | A | 0 | 4.18 | 2.79 × 10⁻⁶ |
| S-18 | 2.65 | A | 0 | 21.01 | 2.18 × 10⁻⁴ |
| S-23 | 1 | A | 0 | 14.53 | 5.10 × 10⁻⁵ |
| S-24 | 2 | A | 0 | 21.16 | 2.02 × 10⁻⁴ |
| S-28 | 1 | A | 0 | 7.44 | 2.78 × 10⁻⁵ |
| (60% YSZ) | | | | | |
| S-29 | 0 | A | 0 | 1.09 | 2.08 × 10⁻⁶ |
| (65% YSZ) | | | | | |
| S-31 | 3 | A | 0 | 25.96 | 3.04 × 10⁻⁴ |
| S-32 | 4 | A | 0 | 28.35 | 7.68 × 10⁻⁴ |
| S-33 | 3 | B | 0 | 5.05 | 5.33 × 10⁻⁶ |
| S-33A | 3 | B | 58 (air) | 19.30 | 6.02 × 10⁻⁴ |
| S-35A | 4 | B | 20 (air) | 33.20 | 4.07 × 10⁻⁴ |
| S-36A | 2 | B | 12 (air) | 30.57 | 6.02 × 10⁻⁴ |
| S-37A | 2 | B | 20 (air) | 17.84 | 9.75 × 10⁻⁵ |
| S-38A | 0 | B | 40 (air) | 22.14 | 1.96 × 10⁻⁴ |

### BRIEF DESCRIPTION OF THE DRAWINGS

FIG. 1 is the sintering temperature setting program A for anode green substrate (sintering curve A), including (a) the first cycle, and (b) the second cycle.

FIG. 2 is the sintering temperature setting program B for anode green substrate (sintering curve B), including (a) the first cycle, and (b) the second cycle.

FIG. 3 is the relationship between the amount of pore former and the porosity for anode supported cell.

FIG. 4 is the relationship between the porosity and gas permeability for anode supported cell under different pore former indexes.

FIG. 5 is the relationship between the porosity and gas permeability for anode supported cell under different pore former indexes and gas flow rates.

FIG. 6 is the relationship between the porosity and gas permeability for anode supported cell under different sintering curves and sintering atmospheres.

FIG. 7 shows gas permeability for anode supported cell under (a) different pore former indexes (sintering curve A) or (b) different air flow rates (sintering curve B, I representing Pore Former Index).

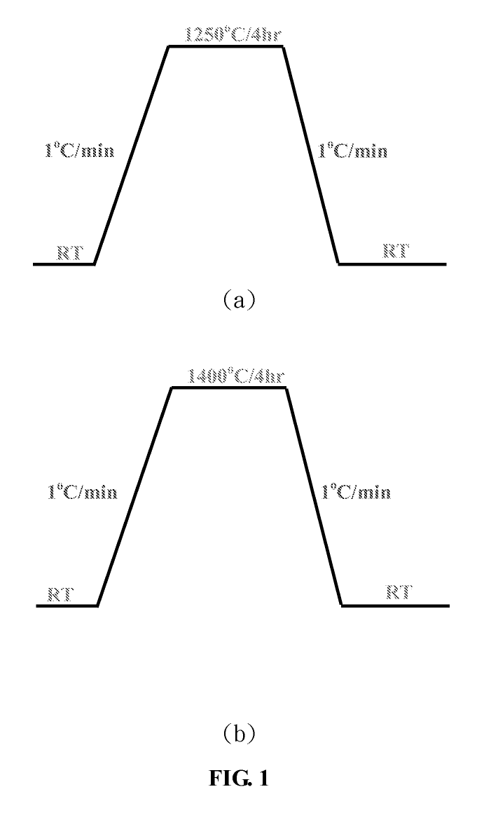

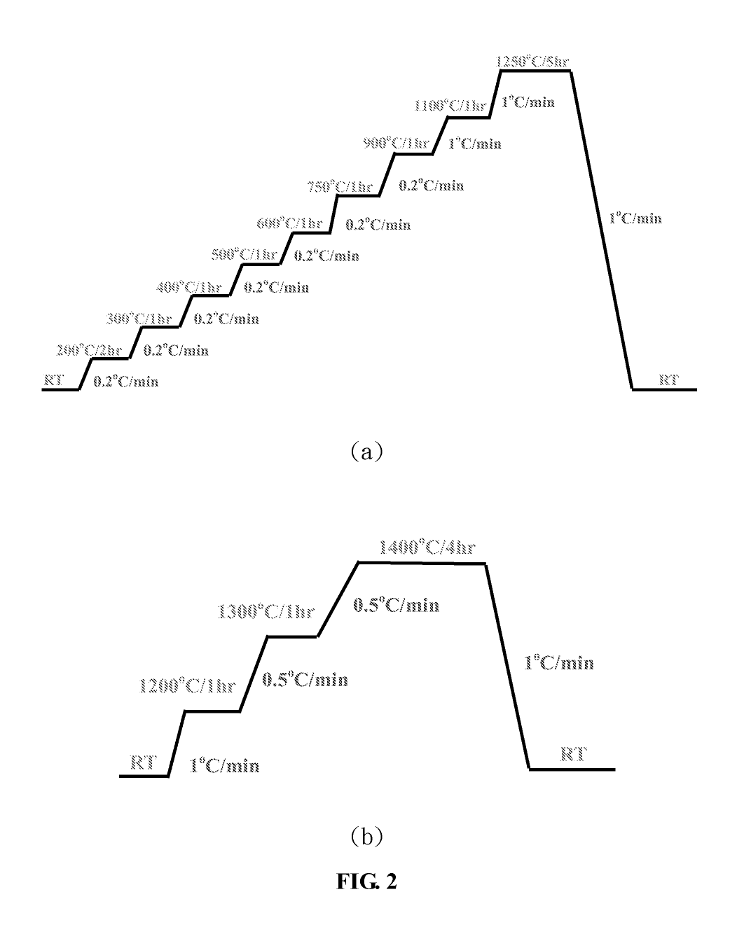

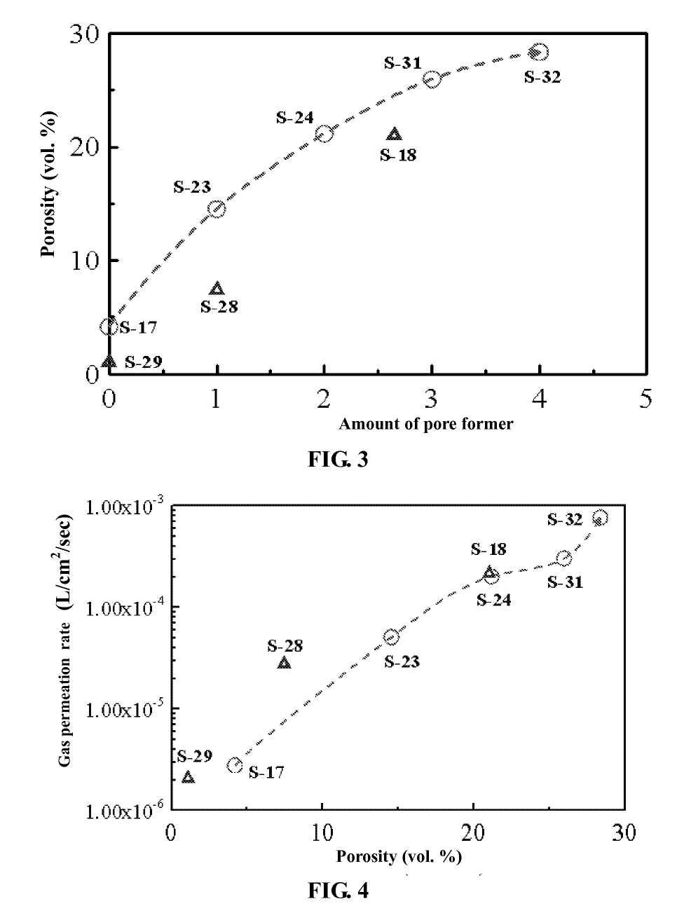

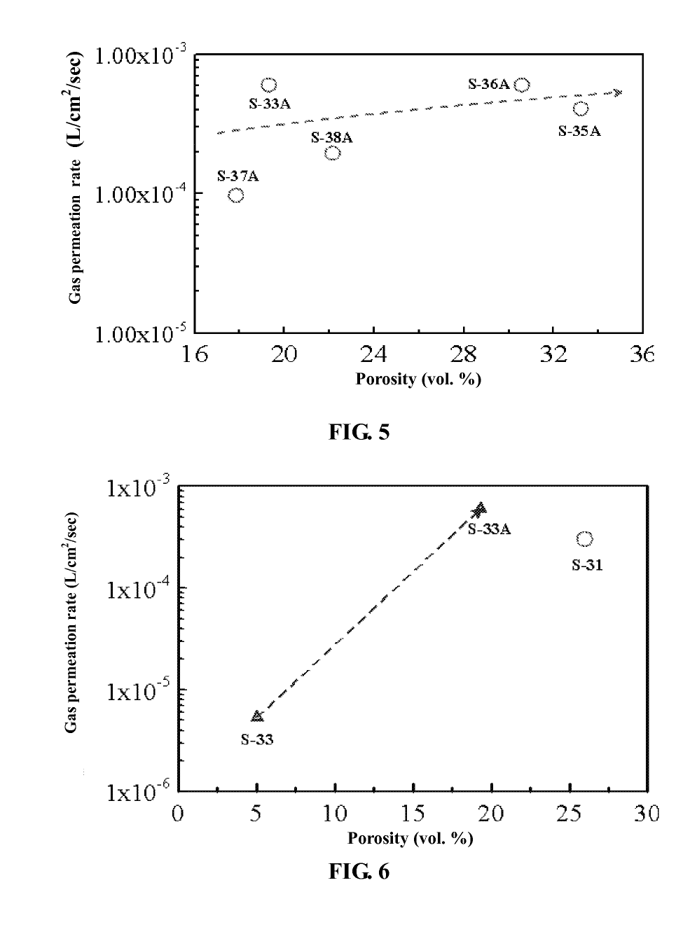

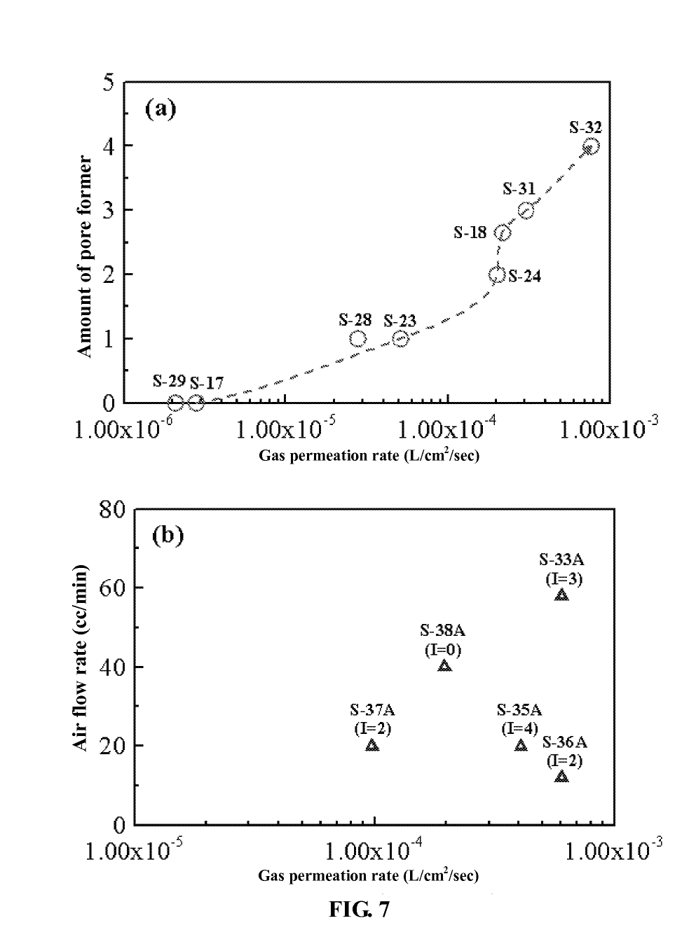

What is claimed is:

1. A manufacturing process for the electrode layer of solid oxide fuel cell (SOFC) with specific porosity and gas permeability; the process that combines sintering and pore former technology at least comprises the following steps:
a) making SOFC anode supported cell or green substrate of electrode; the green substrate can contain pore former to adjust the porosity and gas permeability for the finished electrode substrate;
b) conducting sintering for SOFC electrode green tape from Step a to produce SOFC electrode/anode ceramic supported substrate; the sintering process is carried out in a high-temperature furnace with (1) specific temperature setting program for sintering temperature curve, and (2) specific sintering atmosphere and gas flow rate to produce electrode supported cell with specific porosity and gas permeability;
c) using pycnometer and analytical equipment for gas permeability to measure the porosity and gas permeability of the anode substrate to assure product quality.

2. As described in claim 1 the manufacturing process for the electrode layer of solid oxide fuel cell, it can be, but not limited to, planar, and the electrolyte materials can be, but not limited to YSZ, GDC, LSGM, SDC and YDC etc., and the anode materials can be, but not limited to NiO+YSZ, NiO+GDC, NiO+LSGM, NiO+SDC, and NiO+YDC etc., and the cathode materials can be, but not limited to LSM and LSCF etc.

3. As described in claim 1 the manufacturing process of the electrode layer for solid oxide fuel cell, the pore former in Step a can be, but not limited to, graphite, which at high temperature (higher than 200° C.) can be thermally decomposed or subject to pyrolysis; the amount of pore former is 0.1˜10% of anode materials or pore former index is 0.1˜10.

4. As described in claim 1 the manufacturing process for the electrode layer of solid oxide fuel cell, the sintering temperature in Step b can be, but not limited to, 1700° C., with gas tightness and gas flow control.

5. As described in claim 1 the manufacturing process for the electrode layer of solid oxide fuel cell, the sintering strategy and technique in Step b is to control and execute (1) specific temperature program for sintering temperature curve, and (2) specific sintering atmosphere and gas flow rate.

6. As described in claim 1 the manufacturing process for the electrode layer of solid oxide fuel cell, the sintering process in Step b can be, but not limited to, two cycles (two specific sintering temperature curves); the first cycle can be, but not limited to 1250° C./4 hours, with temperature increasing rate of, but not necessarily, 0˜3° C./min, and temperature decreasing rate of, but not necessarily, 0.5˜3° C./min; the second cycle can be, but not limited to 1400° C./4 hours, with temperature increasing rate of, but not limited to, 0˜3° C./min, and temperature decreasing rate of, but not limited to, 0.5˜3° C./min; when the temperature increasing/decreasing rate is 0° C./min, it indicates the temperature is held constant.

7. As described in claim 1 the manufacturing process for the electrode layer of solid oxide fuel cell, the specific sintering atmosphere in Step b can be, but not limited to, air or inert gases, with flow rate of, but not limited to, 0˜2000 cc/min; when gas flow rate is 0 cc/min, it indicates no gas entering to sintering process, the preferred volume flow rate for air as passing gas can be, but not limited to, 1˜60 cc/min.

8. As described in claim 1 the manufacturing process for the electrode layer of solid oxide fuel cell, the equipment in Step c to measure porosity can be, but not limited to, pycnometer, and for gas permeability measurement the pressure difference between the two sides of the anode supported cell can be, but not limited to, 5 psig.
